(19) United States
(12) Patent Application Publication
(10) Pub. No.: US 2007/0114259 A1
(43) Pub. Date: May 24, 2007

(54) Multi-blow pneumatic hand tool for inserting t-nuts

(75) Inventors: Keith G. Bromley, Sharon (CA); Sung Hsiang Liu, Scarborough (CA)

Correspondence Address: BIRCH STEWART KOLASCH & BIRCH, PO BOX 747, FALLS CHURCH, VA, 22040-0747, US

(73) Assignee: Sigma Tool & Machine

(21) Appl. No.: 11/285,348

(22) Filed: Nov. 23, 2005

(51) Int. Cl. B25C 5/06

(52) U.S. Cl. 227/120

(57) ABSTRACT

A portable device for inserting fixing elements into predefined seats in a work piece, the portable device including a drive head; a drive rod extending downward from the drive head; a hollow nose piece slidably fit around a lower end of the drive rod, the nose piece being attached to the head and being movable vertically by a predetermined distance with respect to the head and the drive rod; a magazine mounted on the nose piece at a predetermined angle with respect to a lower face of the nose piece for feeding a first fixing element into a horizontal slot on the lower face the nose piece; and a drive mechanism providing a pulsating force produced by a pressurized fluid to an upper end of the drive rod when downward pressure is applied by a user on the drive head. The pulsating force on the drive rod drives the first fixing element into the predefined seat in the work piece.

### BACKGROUND OF THE INVENTION

1. Field of the Invention

The present invention relates to a multi-blow pneumatic hand tool for inserting t-nuts, and in particular to a multi-blow pneumatic hand tool for inserting t-nuts having prongs.

2. Description of Background Art

The first commonly available t-nuts were stamped fasteners with a hollow shaft with an internal thread and a flange without prongs. These t-nuts had holes in the flange (usually three) that could accept small nails that would be used to hold the t-nut to the work piece. Later (late 1930's or early 1940's) t-nuts were introduced with prongs that were formed from the flange. These t-nuts would be located over the hole in a work piece and driven into the work piece with a hammer.

In the late 1960s, an “auto-sta” octagonal flange 4-prong t-nut, designed to feed in a track of a machine, and a t-nut machine to drive these t-nuts into the work piece, was developed. Today while a significant percentage of t-nuts are inserted using machinery, a substantial market remains where t-nuts are driven into a work piece by hand using a hammer. Specific areas where t-nuts are inserted with a hammer are:

Small Volume User: Traditional t-nut machines are generally only cost effective when the volume of t-nuts exceeds 50,000, for example.

Assembly Line Insertion: Some companies believe it to be more cost effective to insert t-nuts on the line while the frame is being assembled.

T-nuts in Large Work Pieces: Large work pieces are difficult to handle. In modern furniture production, frames are typically cut from large plywood sheets. When the components are large they can be too big and awkward to manipulate into a t-nut insertion machine.

Work Pieces with Blind Holes: In some applications t-nuts are inserted in a blind hole, such as when used to mount a leveler on a chair leg.

More recently, a pneumatically operated hand tool for inserting t-nuts has been introduced. This device has a magazine that accepts t-nuts that are collated into strips with a flexible adhesive tape, and uses a pneumatic stapler body with a reversed action. When the tool is at rest, the driver is fully extended in the down position and the tip of the driver sticks out the bottom of the nose piece. To operate the tool, the tip of the driver is first placed in the hole. Pressing down on the tool then releases the trigger safety. Squeezing the trigger initiates the following sequence: (1) The driver retracts, a t-nut is advanced into the nose of the tool by a feeder mounted on the magazine; and (2) When the trigger is released, the driver descends, driving the t-nut into the work piece.

While the concept of this pneumatically operated hand tool provides some improvement, the tool disclosed therein requires a careful technique during use to ensure that the t-nut is set into the hole properly. A problem often occurs because the driver is used to locate the hole, and squeezing of the trigger retracts the driver. The recoil of that action often causes the tool to move slightly. As a result, the t-nut is very often driven into the side of the hole, making it very difficult to start a screw in the t-nut. By holding the tool a certain way, it is possible to compensate for the recoil and to drive t-nuts properly, but for many users and environments it has never worked satisfactorily. A further problem with conventional single-shot hand tools is that they typically require a secondary safety to prevent injury. Even with a secondary safety, conventional single-shot tool cannot completely eliminate the risk of injury to the operator. As a result of these problems, these single-shot devices such as this have not gained wide acceptance in the market.

### SUMMARY OF THE INVENTION

According to a one feature consistent with some embodiments of the present invention, a portable device for inserting fixing elements into predefined seats in a work piece is provided. The portable device including a drive head; a drive rod extending downward from the drive head; a hollow nose piece slidably fit around a lower end of the drive rod, the nose piece being attached to the head and being movable vertically by a predetermined distance with respect to the head and the drive rod; a magazine mounted on the nose piece at a predetermined angle with respect to a lower face of the nose piece for feeding a first fixing element into a horizontal slot on the lower face the nose piece; and a drive mechanism providing a pulsating force produced by a pressurized fluid to an upper end of the drive rod when downward pressure is applied by a user on the drive head. The pulsating force on the drive rod drives the first fixing element into the predefined seat in the work piece.

According to another feature consistent with some embodiments of the present invention, the slot of the nose piece is arranged such that the first fixing element is disposed under a lower face of the drive rod and such that a part of the fixing element in the slot projects below the lower face of the nose piece, the projecting part of the first fixing element for locating one of the predefined seats into which the first fixing element is to be inserted.

According to still another feature consistent with some embodiments of the present invention a method for determining multiple predefined seat locations in a work piece and inserting fixing elements into the seats is provided including automatically transferring a first fixing element into a nose piece of a multi-blow pneumatic hand tool, a barrel tip of the fixing element extending below a lower face of the nose piece, moving the nose piece over the work piece until the barrel tip of the first fixing element meets a first predefined seat; inserting the first fixing element into the first seat by applying pressure on the nose piece; automatically transferring a second fixing element from the magazine into the nose piece, a barrel tip of the second fixing element extending below the lower face of the nose piece; moving the nose piece over the work piece until the barrel tip of the second fixing element meets a second predefined seat; inserting the second fixing element into the second seat by applying the pressure on the nose piece; and repeating the steps above until the multiple predefined seat locations are found and filled with the fixing elements.

Further scope of applicability of the present invention will become apparent from the detailed description given hereinafter. However, it should be understood that the detailed description and specific examples, while indicating exemplary embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a line drawing of a multi-blow t-nut hand tool consistent with some embodiments of the present invention;

FIG. 2 is a profile view of the multi-blow t-nut hand tool showing a finger hook of the magazine follower consistent with some embodiments of the present invention;

FIG. 3 is an exploded drawing of nose and driver assembly of hand tool of the embodiment;

FIGS. 4(a) to 4(g) illustrate views of an exemplary individual t-nut and a t-nut strip;

FIGS. 5(a) to 5(g) are cut-away views showing an exemplary sequence of locating a hole and inserting a t-nut;

FIGS. 6(a) to 6(f) are additional views of a nose piece consistent with some embodiments of the present invention;

FIG. 7 is an exploded view of the cap, sleeve valve, cylinder cap, piston and drive rod of the hand tool consistent with some embodiments of the present invention;

FIGS. 8(a) and 8(b) are 3-d views of the nose piece assembly of an alternative embodiment of the present invention;

FIGS. 9(a) to 9(c) illustrate the functioning of the L-shaped fingers of the alternative embodiment shown in FIGS. 8(a) and 8(b);

FIGS. 10(a) and 10(b) provide exterior 3-d views of the nose piece assembly with an adjustable upper stop and a lower contact element consistent with some embodiments of the present invention, FIG. 10(c) provides a side view of the nose piece assembly with an adjustable upper stop and a lower contact element, and FIG. 10(d) provides a 3-d view of the lower contact element;

FIGS. 11(a) and 11 (b) are cutaway views of the nose piece assembly with the adjustable upper stop and lower contact element shown in FIGS. 10(a) to 10(d); and

FIGS. 12(a), 12(b), and 12(c) provide two exterior 3-d views and a side view of the nose piece assembly having a combination lower contact element and upper stop consistent with some embodiments of the present invention.

### DETAILED DESCRIPTION

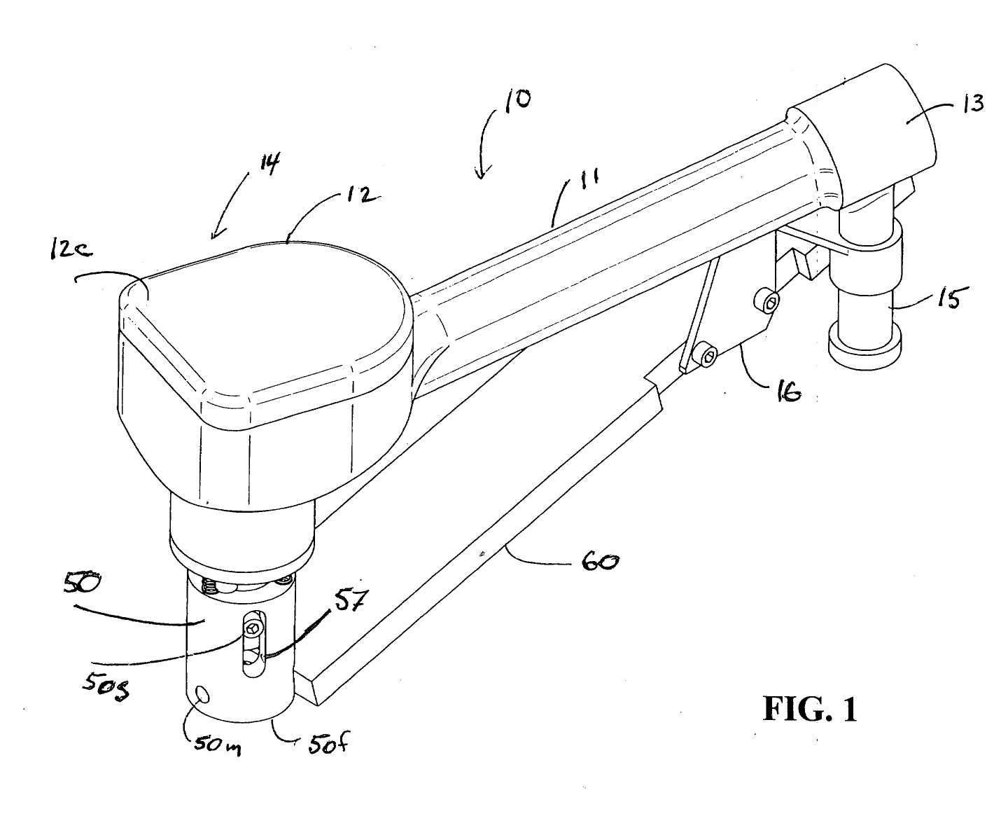

The multi-blow pneumatic hand tool for inserting t-nuts consistent with some embodiments of the present invention of the present invention is described with reference to FIGS. 1-3.

As can be seen, the multi-blow pneumatic hand tool 10 for inserting t-nuts 100 has a nose piece and magazine combination (nose piece 50, angled magazine 60), the combination being slidingly attached to a multi-blow pneumatic drive head 12 and a butt 13 of the casing 14 of the multi-blow t-nut hand tool 10. The magazine and nose piece combination and multi-blow pneumatic drive head 12 are described below.

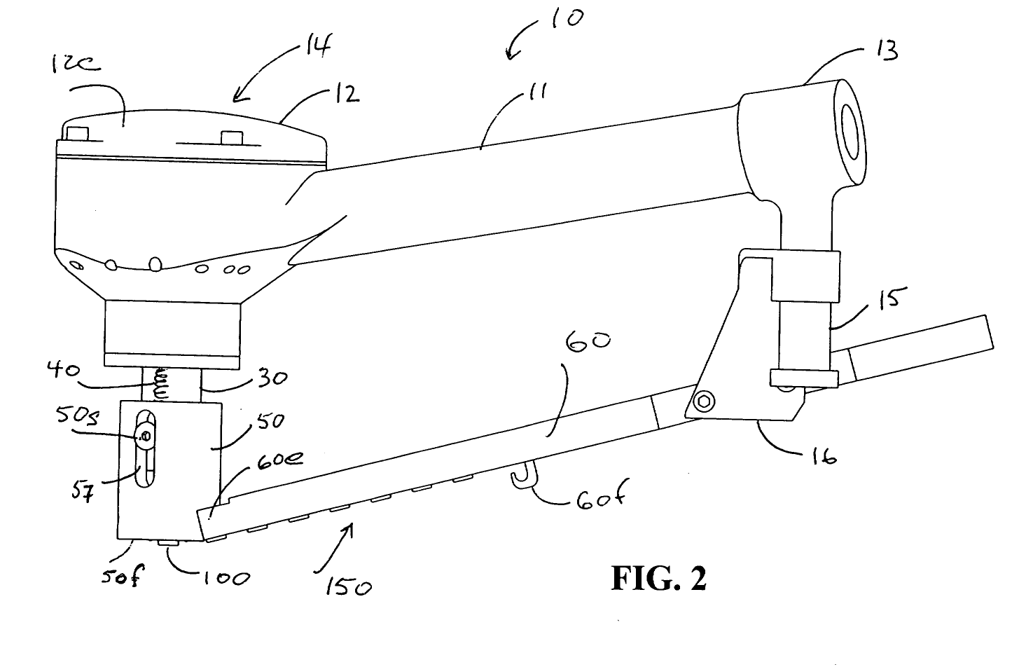

Magazine holding bracket 16 is slidably mounted on shaft 15 that extends downward from butt end 13 of the handle 12. Magazine holding bracket 16 is also fastened to the magazine 60 by fasteners 16s. Since a front end 60e of the magazine 60 is rigidly attached to the nose piece 50 and a rear end of the magazine 60 is attached to bracket 16, the magazine 60 moves up and down together with movement of the nose piece 50. The magazine 60 has a slot 60s for receiving a strip 150 of collated t-nuts 100 and a spring-loaded follower (not shown) that presses the strip 150 towards the nose piece 50, advancing one of the t-nuts 100 in the strip 150 into the nose piece 50 after every insertion. In FIG. 2, the follower (not shown) includes a finger hook 60f that is used to pull the follower back against the force of the magazine spring during the process of loading a strip 150 of multiple t-nuts 100. When pushed from the magazine 60 into the nose piece 50, the orientation of the t-nut 100 changes from an angle in the range of 20° to 45° with respect to horizontal. A magnet 50m positioned in the front of the nose piece 50 draws the t-nut 100 into a horizontal position in the nose piece 50.

The multi-blow pneumatic drive head 12 of the present invention is based on a conventional “palm nailer”. A palm nailer is a tool that can be used to drive nails right up to large spikes without using a hammer. When connected to compressed air, a palm nailer responds to pressure against the driver. As long as pressure is applied, the palm continues to cycle, delivering blow after blow. As soon as pressure is removed, the driving stops. On the t-nut hand tool 10 of the present invention, the multi-blow drive head 12 may feature a cap 21c and an ergonomic handle 11 for user convenience and ease of use. In contrast to a conventional palm nailer, which uses a driver that is usually a short round rod that barely protrudes from the base of the tool, the t-nut hand tool 10 of the present invention uses a long drive rod 20 with a large diameter tip.

In the multi-blow pneumatic hand tool for inserting t-nuts 100, the magazine/nose piece combination is attached to the drive head 12 in such a way that the magazine 60 and nose piece 50 may slide up and down along an extension tube 30 which is mounted by screws 30s on the bottom of the drive head 12. A mechanism prevents the nose piece/magazine from falling off the extension tube 30. In some embodiments, the mechanism may include a vertical slot 57 machined into a side of the nose piece 50 through which a screw 50s is fastened to the extension tube 30. The nose piece 50 is able to slide up and down the extension tube 30 only over the length of the slot 57. One or more springs 40 may be fitted between the nose piece 50 and the drive head 12, in order to bias the nose piece 50 away from the drive head 12.

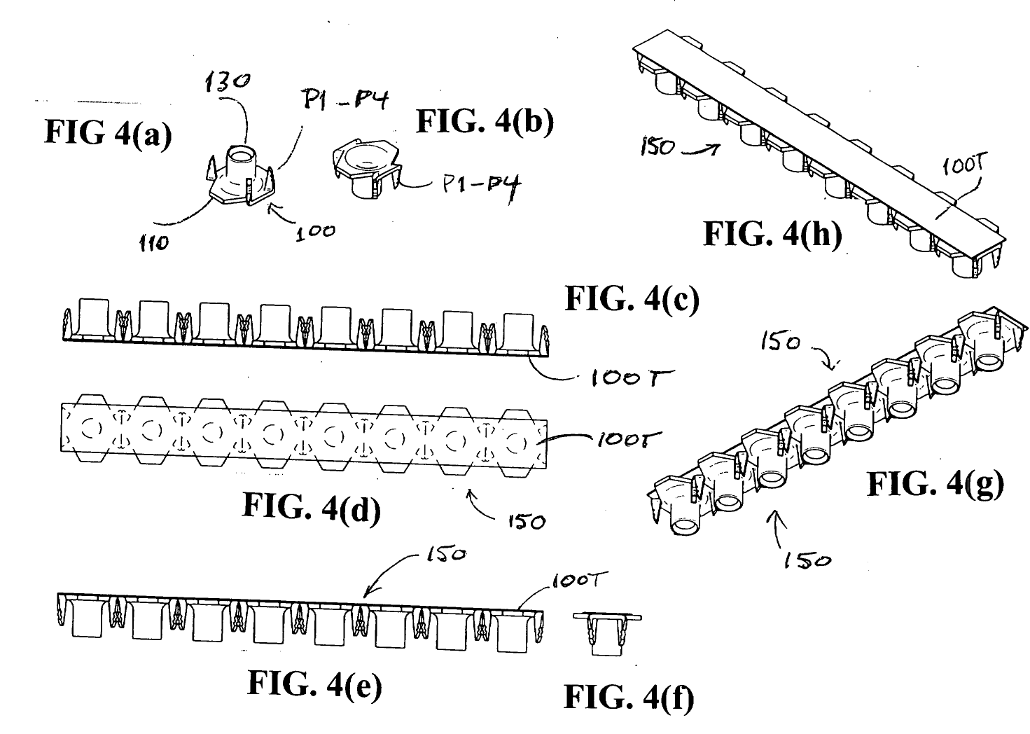

FIGS. 4(a) to 4(h) provide views of an exemplary individual t-nut 100 and a t-nut strip 150. FIGS. 4(a) and 4(b) shown perspective views on an individual t-nut 100. As can be seen, the t-nut 100 includes a barrel 130, flange 110 and multiple prongs P1 to P4. FIGS. 4(c) to 4(h) show a strip 150 oft-nuts 100 collated and held in place by a strip of tape 100T. FIGS. 4(c) and 4(e) are side views, FIG. 4(d) is a plan view, FIG. 4(f) is an end view, and FIGS. 4(g) and (h) are perspective views of the strip 150 of t-nuts 100. The multi-blow pneumatic hand tool of the present invention may accommodate t-nuts having various base sizes, for example, a small base: 0.625″×0.700″, a large base: 0.830″×0.885″, or other sizes smaller or greater than these.

The tape 100T is formed with adhesive on the side applied to the bottom of the t-nuts 100. Any commonly known material may be used for the adhesive tape 100T. Once the t-nuts 100 are collated into a strip 150, the strip 150 is ready to be inserted into the magazine 60.

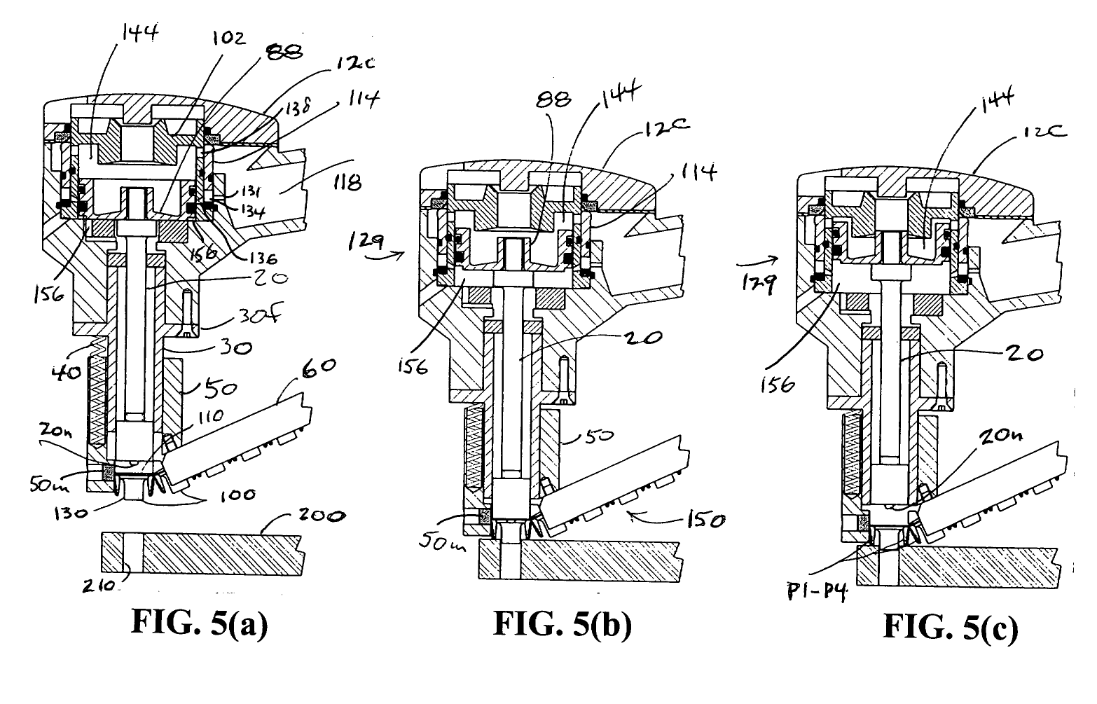

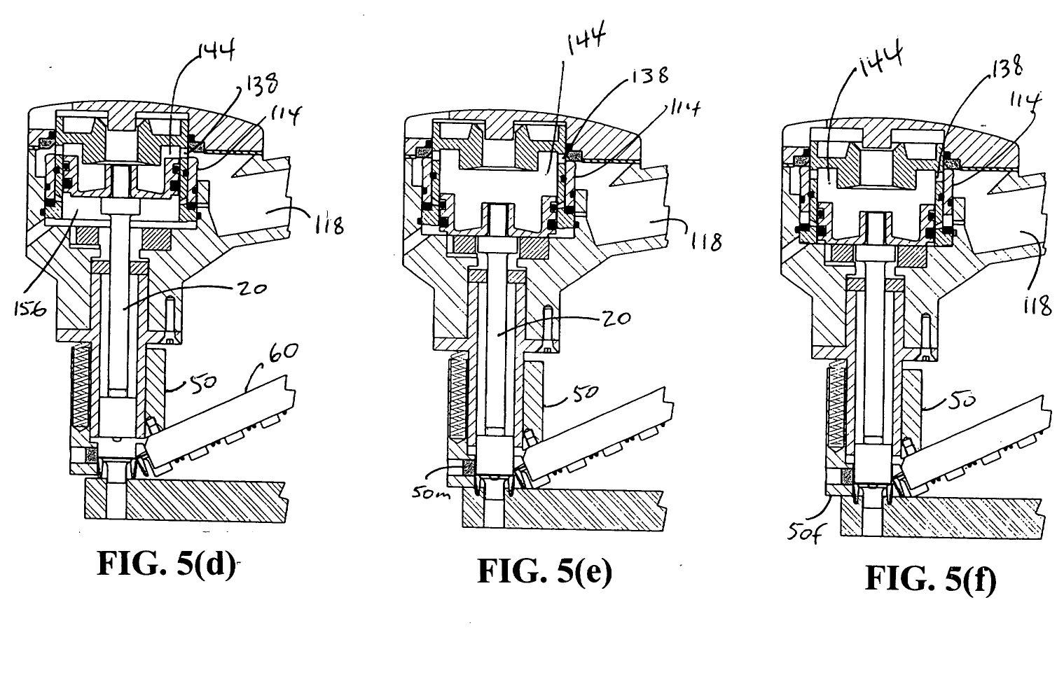

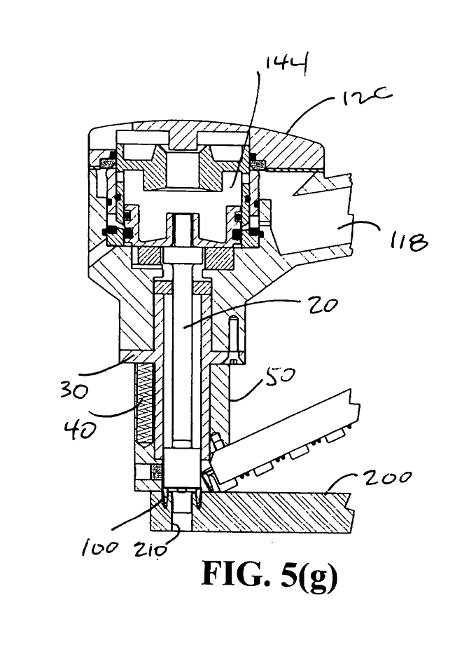

Referring to FIGS. 5(a) to 5(g), the multi-blow pneumatic drive head 12 will be described. FIGS. 5(a) to 5(g) also show a sequence of using the hand tool 10 for locating a hole 210 in the work piece 200 and inserting a t-nut 100 into the hole 210.

As shown, the multi-blow pneumatic drive head 12 is provided with a cylinder 129. A drive piston 88 is slidably disposed in the cylinder 129 and fixed to the top of drive rod 20 for cycling the drive rod 20 upward and downward under the influence of bursts of compressed air from air supply passage 118 alternately supplied to air chamber 156 below the piston 88, and air chamber 144 above the piston 88. Bursts of compressed air alternately enter air chamber 144 or air chamber 156, depending on the position of sleeve valve 114.

In FIG. 5(a) the hand tool 10 is in a rest position, above the work piece 200, and there is a gap between the bottom end of the drive rod 20 and the flange 110 of the t-nut 100 that is positioned in the nose piece 50. In FIG. 5(a) tip of the barrel 130 of the t-nut is not yet inserted into the hole 210. Piston 88 is in a rest position against the bottom of the cylinder 129, thus blocking entry of compressed air in supply passage 118 from entering into air chamber 156 through ports 131, 136. Further, sleeve valve 114 is in an up position, thus preventing compressed air from leaving air supply passage 118 and entering air chamber 144 through port 138.

In FIG. 5(b), the drive cycle of the hand tool 10 is triggered when the hand tool is pressed down on the flange 110 of the t-nut 100. As the drive cycle continues, the tip of the t-nut barrel 130 is partially inserted into hole 210. The upward pressure on the drive rod 20 pushes piston 88 upward and allowing air to flow into air chamber 156. FIG. 5(c) illustrates an upward stroke of the drive rod 20 during the cycling of the drive rod 20.

FIG. 5(d) illustrates the sleeve valve 114 moved away from port 138, and a drive stroke initiated by a burst of compressed air that now enters upper air chamber 144 through port 138. In FIG. 5(e), the drive stoke of the drive rod 20 moves to completion, port 138 is closed by the sleeve valve 114, and simultaneously ports 131, 136 are closed off by the piston 88. FIG. 5(e) also shows that the prongs P1-P4 of the t-nut 100 partially inserted into the work piece 200.

FIG. 5(f) illustrates the cycle finished, the sleeve valve 114 reset, and ready for the next cycle. FIG. 5(g) illustrates the t-nut 100 is fully inserted into the hole 210 and the cycling being stopped. The top of the nose piece 50 is pressed upward against the downward pressure of the spring(s) 40 to make contact with the flange 30f of the extension tube 30, and the drive rod 20 is fully extended. The repetitive driving blows of the hand tool 10 stop when the t-nut 100 is not pressing up on the drive rod 20, and no matter how much downward force the operator applies to the tool 10 the t-nut 100 cannot be driven further into the work piece 200.

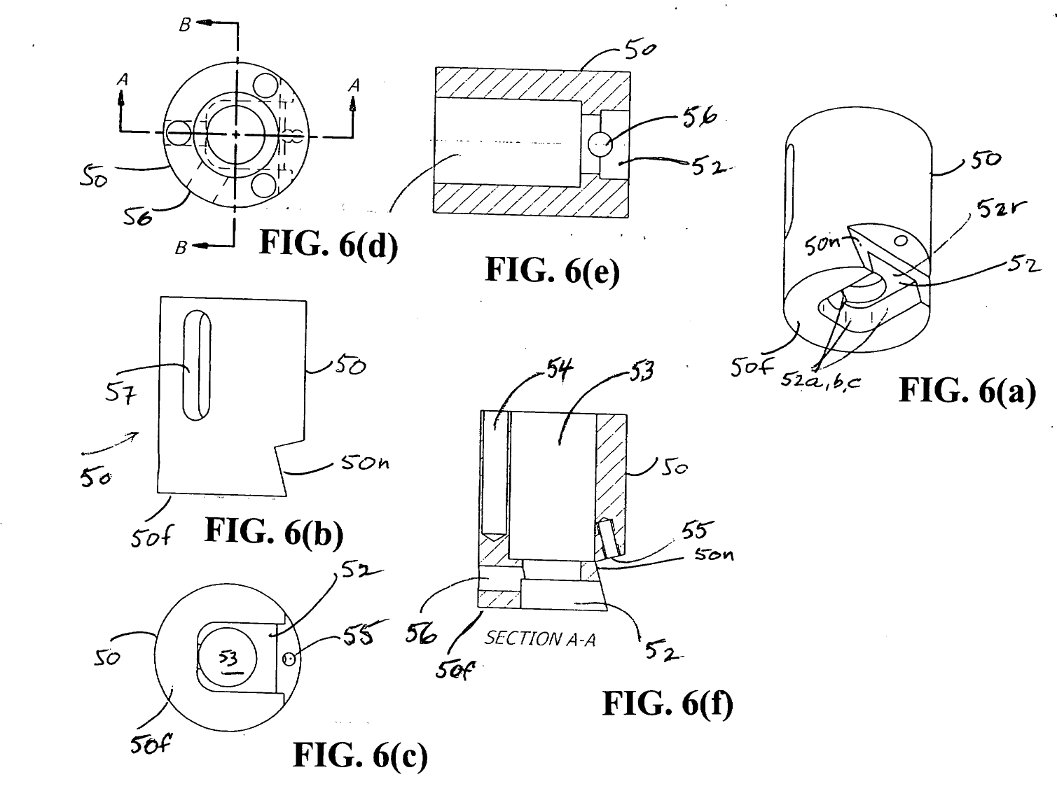

Next, operation of hand-tool is described with reference to FIGS. 5(a) to 5(g). First, an operator loads a strip 150 oft-nuts 100 into the magazine 60 of the hand tool 10. The spring loaded follower (not shown) pushes on the distal end of the strip 150, bringing the first t-nut 100 into position in the nose piece 50. Magnet 50m holds the t-nut 100 in place in slot 52 (see FIGS. 6(a) to 6(f)). The barrel 130 of this t-nut 100 protrudes downward below the magazine 60 and the barrels of the other t-nuts 100 in the strip 150. The operator then locates the tip of the barrel 130 of the first t-nut 100 into the hole 210 in the work piece 200. The operator then presses down on the drive head 12 of the hand tool 10, the drive head 12 moves downward against the spring pressure (of spring(s) 40) towards the nose piece 50 and magazine 60.

The operator continues pressing down until the tip of the drive rod 20 contacts the t-nut 100 in the nose piece 50. The drive head 12 then cycles continuously as the operator maintains downward pressure, driving the prongs P1-P4 of the t-nut 100 into the work piece 200 and breaking the tape 100T that connects t-nut 100 to the remaining t-nuts in the collated strip. Since the drive rod 20 has a relatively short stroke and produces a low impact, the hand tool is inherently safe, with virtually no risk of injury. Further, as compared to a single blow hand tool, the multi-blow pneumatic hand tool 10 needs to deliver only a small amount of power in each of the multiple blows in order to insert each t-nut 100. When the t-nut 100 is completely driven into the work piece 200, the operator stops applying downward pressure and the drive head 12 stops cycling. The operator then lifts the hand tool 10 off the work piece 200, the spring(s) 40 push the drive head 12 and the magazine 60 apart. When the nose piece 50 and magazine 60 are fully extended, the follower is able to push the next t-nut 100 into position in the nose piece 50 and the hand tool 10 in ready to insert the next t-nut 100 into the next hole.

In some applications, foam may be injected around a wood or plastic work piece 200 after the t-nut 100 is inserted. In these cases, it is common for the flange 110 of the t-nut 100 to be covered with a tape in order to prevent foam from reaching the threads inside the t-nut 100. Since the multi-blow pneumatic hand tool 10 for inserting t-nuts 100 of the present invention locates the hole 210 in the work piece 200 by actually placing the t-nut 100 in the hole 210, the need in conventional devices or machines for a separate device to carry the t-nut 100 from the track or magazine to the hole can be eliminated. For this reason, the drive rod 20 of the hand tool 10 of the present invention has only a small locating nib 20n (hemispherically-shaped), as opposed to the long guide pin, typically found in conventional devices. If a flexible tape 100T is used to collate the t-nut strips 150, the nib 20n does not pierce the tape 100T, leaving it intact on the flange 110 of the t-nut 100. This can eliminate the need for a secondary taping operation for applications involving injected foam.

FIGS. 6(a) to 6(d) include a perspective view, a side view, a bottom view, and a plan view, respectively, of nose piece 50. FIG. 6(e) is a sectional view taken along line A-A of FIG. 6(d), and FIG. 6(f) is a sectional view taken along line B-B of FIG. 6(d). Note particularly that when the t-nut 100 is in position in the nose piece 50, it is constrained by the slot 52 from moving upwardly by a roof 52f of the slot 52, or from moving laterally by side walls 52a, 52b, 52c of the slot 52. FIGS. 6(a) to 6(f) also show central bore 53, one or more spring holes 54 for accommodating spring(s) 40, vertical slot 57, notch 50n for accommodating a front end 60e of the magazine 60, screw hole 55 for accommodating screw 60s and rigidly attaching the front end 60e of magazine 60 to the nose piece 50, spring holes 54, bottom face 50f of the nose piece 50, and bore 56 for insertion of a magnet 50m into the nose piece 50.

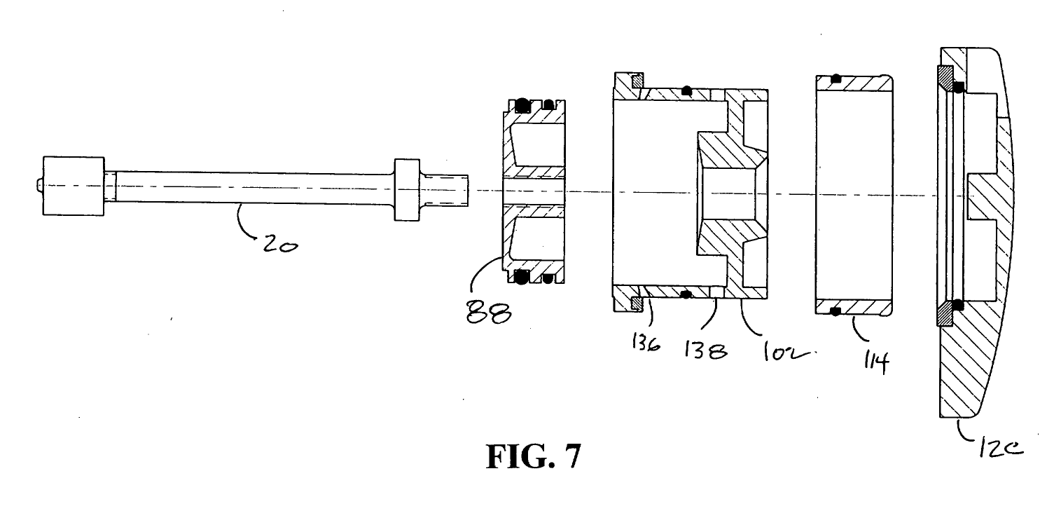

FIG. 7 is an exploded view of the cap 12, sleeve valve 114, cylinder cap 102 with ports 136 and 138, piston 88, and drive rod 20 of the multi-blow pneumatic hand tool 10 of one embodiment of the invention.

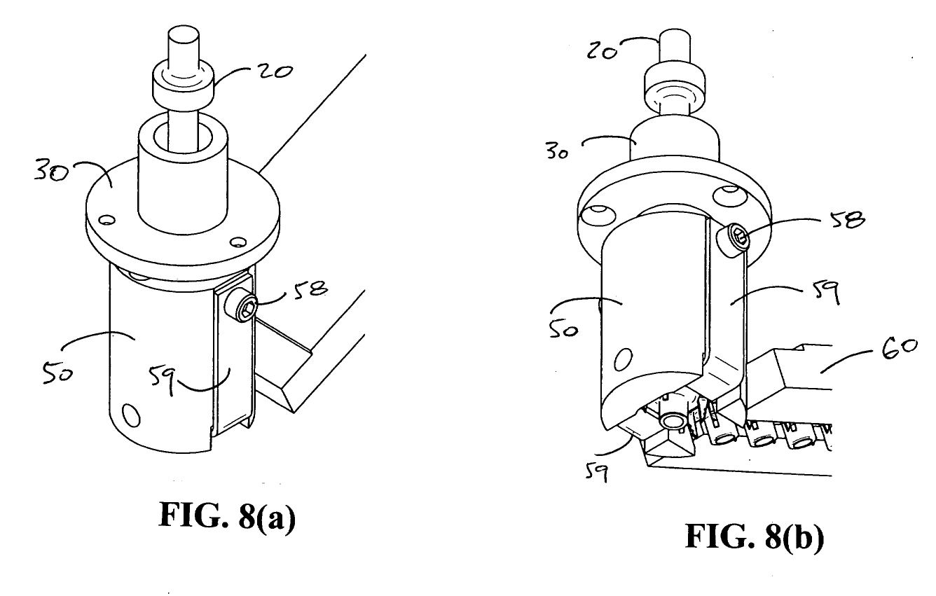

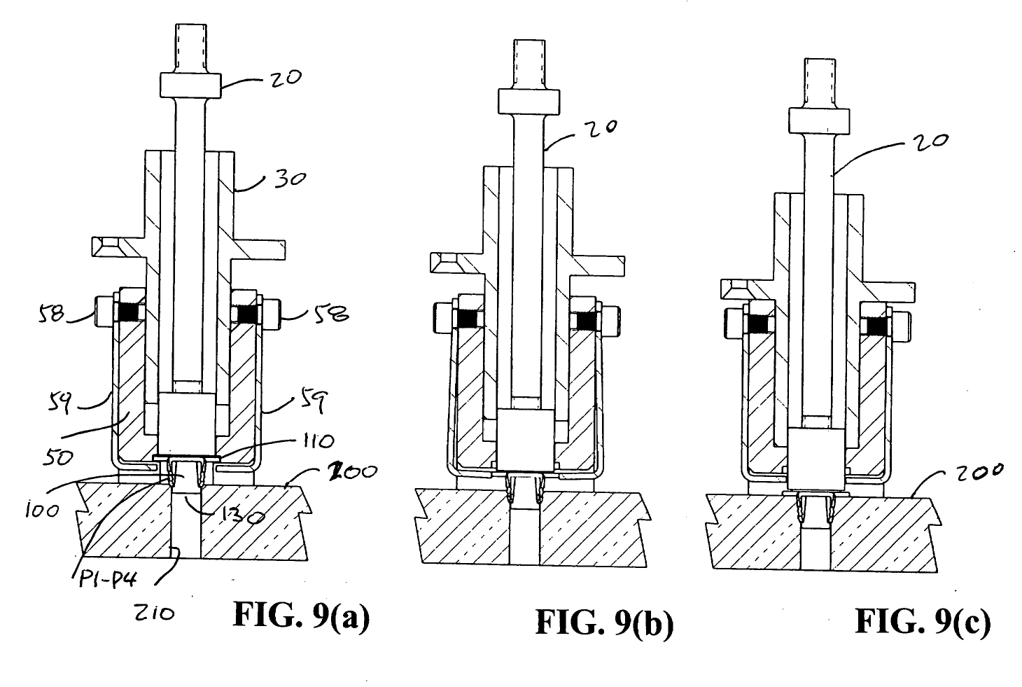

FIGS. 8(a) and 8(b), and FIGS. 9(a) to 9(c), are exemplary illustrations of an alternative embodiment of the present invention. FIGS. 8(a) and 8(b) are 3-d views of the nose piece 50 assembly from the exterior. Whereas the embodiments described above used a magnet 50m to retain the t-nuts 100 in the nose piece 50, this alternative embodiment employs L-shaped fingers 59 attached to the nose piece 50 to retain the t-nut 100 in the nose piece 50. Further, the magnet 50m may also be used in conjunction with the L-shaped fingers 59. The L-shaped fingers 59 in this embodiment are made of flexible spring strips, such as a flexible steel material, or other flexible material, and are attached to the nose piece 50 by means of fasteners 58.

FIGS. 9(a) to 9(c) illustrate the functioning of the L-shaped fingers 59 showing the cutaway drawings of the nose piece 50 during three successive stages of insertion.

FIG. 9(a) illustrates the t-nut barrel 130 (slightly inserted into the hole 210) prior to insertion of the prongs P1-P4 into the work piece 200. The L-shaped fingers 59 can be seen retaining the flange 110 of the t-nut 100 in the nose piece 50.

FIG. 9(b) illustrates shows the t-nut 100 is being pushed past the L-shaped fingers 59, the fingers being forced open to allow the flanges 110 of the t-nut 100 to pass.

In FIG. 9(c) the insertion of t-nut 100 is complete. The t-nut 100 is fully inserted into the work piece 200, and the drive rod 20 in a fully extended position.

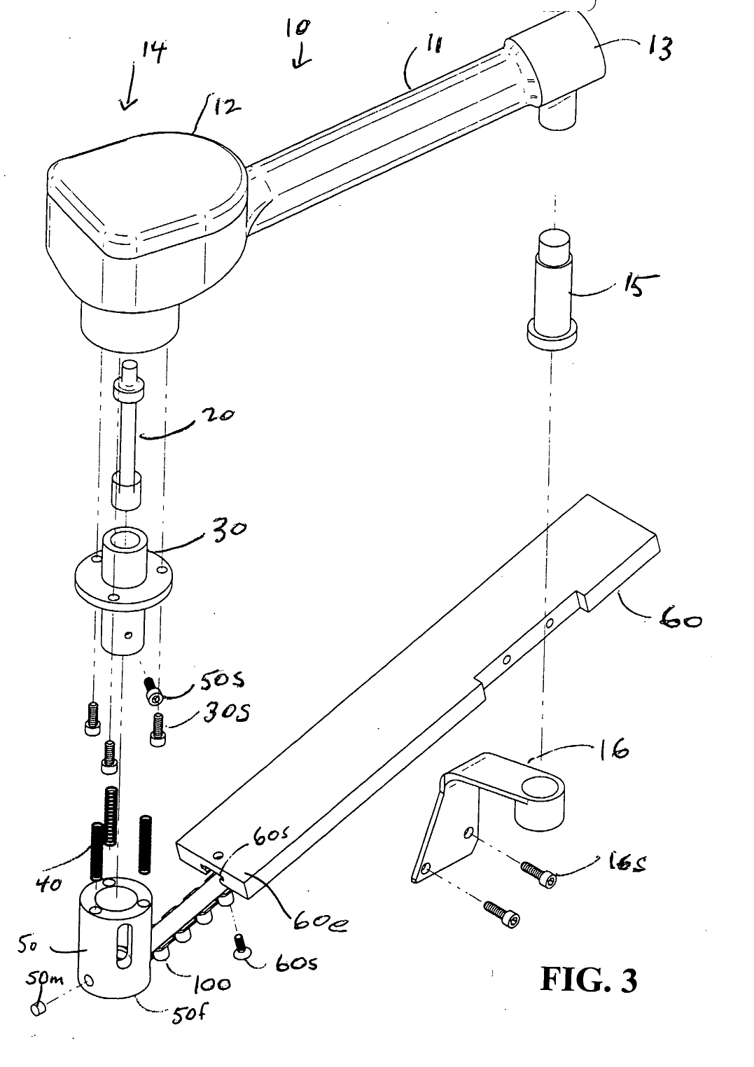

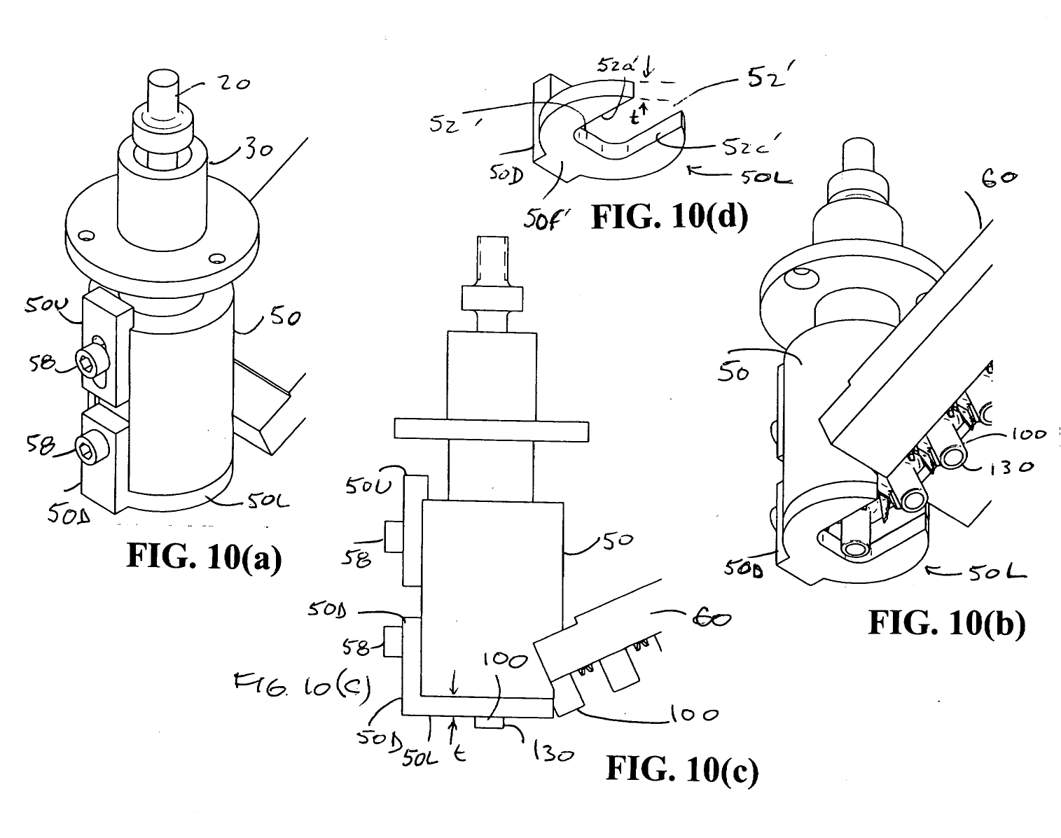

Next, referring to FIGS. 10(a) to 10(d), 11(a), 11(b), and 12(a) to 12(c), additional features of the invention will be described. These FIGS. illustrate exemplary means for (1) adjusting the stoke of the nose piece/magazine assembly, and for (2) adapting the tool to accommodate t-nuts having barrels of different heights. Note that to improve clarity, the spring(s) 40 between the nose piece 50 and the extension tube 30 (shown earlier in FIGS. 1 and 3) are not shown FIGS. 10(a) to 10(d), 11(a), 11(b), and 12(a) to 12(c).

FIGS. 10(a) and 10(b) provide two exterior 3-d views of nose piece assembly with (1) an exemplary adjustable upper stop 50U to control the range of movement of the nose piece/magazine on the extension tube 30 that is mounted to the housing of the drive head 12, and (2) an exemplary lower contact element 50D. FIG. 10(c) is a side view of the nose piece assembly with the adjustable upper stop 50U and the lower contact element 50D. FIG. 10(d) is a 3-d view of the lower contact element 50D. the

Adjustable upper stop 50U and lower contact element 50D are used to control the depth to which the t-nut 100 is driven (for example, if the user would like the upper surface of the flange 110 of the t-nut 100 driven flush with the work piece 200, or to have the flange 110 remain above the surface of the work piece 200) and also to configure the hand tool 10 to work with t-nuts 100 having barrels 130 with different lengths. Common t-nuts have barrel lengths in the range of ¼″ to ⅝″. However, the hand tool 10 of the present invention may be configured to accommodate t-nuts with barrel lengths in the range of 3/16″ to ⅞″, or lengths outside this range.

The adjustable upper stop 50U is generally rectangular in shape and may be formed with a side slot for adjusting upper slot 50U up and down by the length of the slot against the side of the nose piece 50. The adjustable upper stop 50U may be held in place by one or more screws 58.

As can be seen in FIG. 10(d), the lower contact element 50D generally is an L-shaped element 50D, and includes a lower portion 50L which extends under the lower face 50f of the nose piece 50. As such, the lower portion 50L of the lower contact element 50D extends the length of the nose piece 50, enabling the nose piece 50 to accommodate t-nuts having barrels 130 of different lengths. The lower portion 50L of the lower contact element 50D is formed a slot 52′, the slot 52′ having sides walls 52a′, 52b′, and 52c′. Slot 52′ of lower contact element 50D has lateral dimensions substantially equal to those of slot 52 of the nose piece 50. The lower portion 50L of the lower contact member 50D has a predetermined thickness t, the thickness t being set to accommodate t-nuts 100 having barrels 130 of different lengths. As with the upper stop 50U, the lower contact member 50D may be held in place by one or more screws 58. Optionally, the lower contact element 50D may be provided with a side slot (not shown) to allow for up and down adjustment.

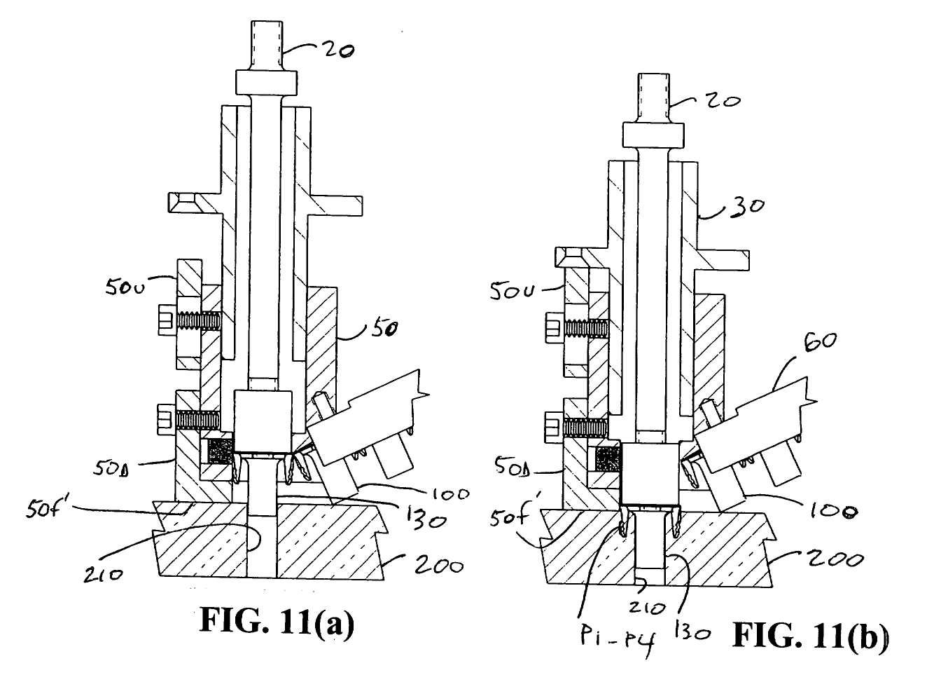

FIGS. 11(a) and 11 (b) are cutaway views of a nose piece assembly with the exemplary adjustable upper stop 50U and lower contact element 50D, configured for a t-nut 100 with a longer barrel 130.

FIG. 11(a) illustrates the lower contact element 50D attached to the nose piece 50, so that the lower face 50f′ of the lower contact element 50D is flush with the lowest part of the first t-nut 100 in the magazine 60 (not the t-nut 100 in the nose piece 50, as shown in FIG. 11(b)). When the operator locates the hole 210 in the work piece 200 with the end of the barrel 130 of the t-nut 100 in the nose piece and presses down on the hand tool 10, the pressure is applied to the lower contact element 50D, and not the t-nut 100 in the magazine 60. FIG. 11(b) illustrates the setting of the upper stop 50U, which prevents further downward movement of the drive head 12 once the t-nut 100 in the nose piece has been inserted to the desired depth into the work piece 200.

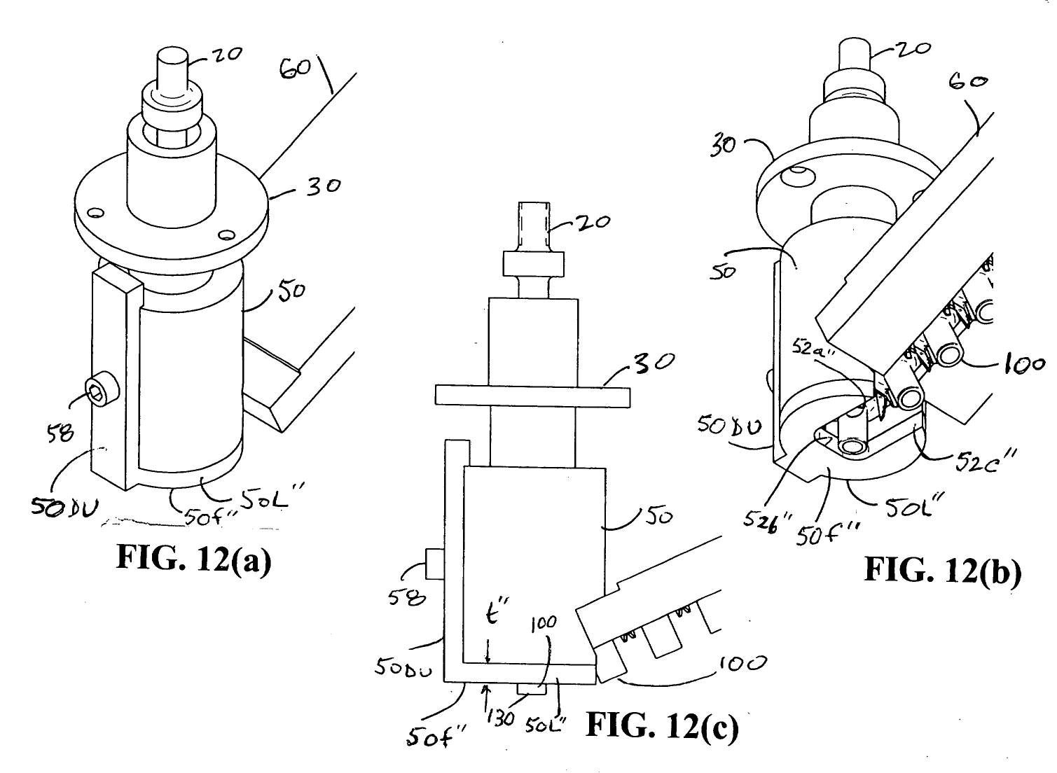

FIGS. 12(a), 12(b), and 12(c) provide two exterior 3-d views and a side view of the nose piece assembly with an exemplary combination contact element and upper stop 50DU. As can be seen, the combination lower contact element and upper stop 50DU has a lower portion 50L″ which extends under the lower face 50f of the nose piece 50. As such, the combination lower contact element and upper stop 50DU extends the length of the nose piece 50, enabling the nose piece 50 to accommodate t-nuts having barrels 130 of different lengths. The lower portion 50L″ of the combination lower contact element and upper stop 50DU is formed a slot 52″, the slot 52″ having sides walls 52a″, 52b″, and 52c″. Slot 52″ of the combination lower contact element and upper stop 50DU has lateral dimensions substantially equal to those of slot 52 of the nose piece 50. The lower portion 50L″ of the combination lower contact member and upper stop 50DU has a predetermined thickness t″, the thickness t″ being set to accommodate t-nuts 100 having barrels 130 of different lengths.

In a manner similar to that shown in FIG. 11(a), and as can be seen in FIG. 12(c), the lower face 56f″ of the lower portion 50L″ of the combination lower contact element and upper stop 50DU is flush with the lowest part of the first t-nut 100 in the magazine 60 (not the t-nut 100 in the nose piece 50). When the operator locates the hole 210 in the work piece 200 with the end of the barrel 130 of the t-nut 100 and presses down on the hand tool 10, the pressure is applied to the combination lower contact element and upper stop 5)DU, and not the t-nut 100 in the magazine 60.

Additional alternative embodiments may include one or more of the following features.

The multi-blow pneumatic hand tool of the present invention may be adapted to accommodate a wide variety of t-nuts, including t-nuts having different base widths and barrel lengths, and t-nuts with and without prongs. Also, t-nuts with any number of prongs may be accommodated. Further, the front end 60e of magazine 60 may be attached to the nose piece 50 by means other than screw 60s. In addition, magazines and t-nut feeding devices of various sizes and shapes may be attached to the nose piece 50. These magazines and t-nut feeding devices may accommodate strips of 15, 20, 50 or 100, or more t-nuts, depending on the base size of the t-nut and the particular magazine or t-nut feeding device used. Still further, while three springs 40 are shown in the nose piece 50, one, two, or four springs may be used instead.

Also, while slot 57 and screw 50s are used for limiting the up and down movement of the nose piece 50, other mechanisms may be used. Further, while the L-shaped fingers 59 are shown separately from the adjustable upper stopper 50U, L-shaped lower contact element 50D, and the combination lower contact element and upper stop 50 DU, the L-shaped fingers 59 are compatible with any of the components 50U, 50D, and 50DU.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A portable device for inserting fixing elements into predefined seats in a work piece, the portable device comprising:
a drive head;
a drive rod extending downward from the drive head;
a hollow nose piece slidably fit around a lower end of the drive rod, the nose piece being attached to the head and being movable vertically by a predetermined distance with respect to the head and the drive rod;
a magazine mounted on the nose piece at a predetermined angle with respect to a lower face of the nose piece for feeding a first fixing element into a horizontal slot on the lower face the nose piece; and
a drive mechanism providing a pulsating force produced by a pressurized fluid to an upper end of the drive rod when downward pressure is applied by a user on the drive head,
wherein the pulsating force on the drive rod drives the first fixing element into the predefined seat in the work piece.

2. The portable device for inserting fixing elements according to claim 1, wherein the slot of the nose piece is arranged such that the first fixing element is disposed under a lower face of the drive rod and such that a part of the fixing element in the slot projects below the lower face of the nose piece, the projecting part of the first fixing element for locating one of the predefined seats into which the first fixing element is to be inserted.

3. The portable device for inserting fixing elements according to claim 1, further comprising an extension tube fixed to a lower side of the head,
the nose piece being movable vertically with respect to the extension tube and the drive rod by the predetermined distance.

4. The portable device for inserting fixing elements according to claim 3, wherein the nose piece is provided with a vertical slot on a side thereof, and a screw fastened to the extension tube and extending through the vertical slot of the nose piece prevents the nose piece from moving beyond the predetermined distance.

5. The portable device for inserting fixing elements according to claim 1, further comprising a spring to bias the nose piece away from the drive head when upward pressure is not applied to the nose piece.

6. The portable device for inserting fixing elements according to claim 5, as the drive rod drives the first fixing element into the predefined seat, the nose piece receives an upward pressure from an area of the work piece around the seating, thus causing the nose piece to move upward toward the drive head.

7. The portable device for inserting fixing elements according to claim 1, wherein the magazine is attached to the nose piece and the hand grip at an angle with respect to a horizontal, so that a barrel of the first fixing element extends further downward than barrels of the fixing elements remaining in the magazine.

8. The portable device for inserting fixing elements according to claim 7, wherein the magazine moves up and down together with the nose piece.

9. The portable device for inserting fixing elements according to claim 1, wherein the fixing elements are collated into a strip and connected by a tape, the collated strip of the fixing elements being inserted into the magazine.

10. The portable device for inserting fixing elements according to claim 9, wherein after the first fixing element is driven into the predefined seat and the portable device is lifted away from the work piece, a follower in the magazine advances the remaining fixing elements in the strip, so that a next fixing element is fed into the horizontal slot on the lower face of the nose piece.

11. The portable device for inserting fixing elements according to claim 1, wherein the nose piece is provided with a magnet for holding the first fixing element in the horizontal slot.

12. The portable device for inserting fixing elements according to claim 1, wherein the nose piece is provided with fingers for holding the first fixing element in the horizontal slot.

13. The portable device for inserting fixing elements according to claim 1, wherein the horizontal slot prevents the fixing elements from moving or rotating laterally.

14. The portable device for inserting fixing elements according to claim 1, wherein the drive mechanism includes upper and lower air chambers with a piston connected to the drive rod disposed therebetween, and
wherein downward pressure on the drive head causes the pressurized fluid to be alternately supplied to the upper and lower air chambers, thus driving the drive rod up and down.

15. The portable device for inserting fixing elements according to claim 1, wherein a part of the first fixing element in the slot projects below the lower face of the nose piece, the projecting part of the first fixing element for locating one of the predefined seats into which the first fixing element is to be inserted

16. The portable device for inserting fixing elements according to claim 1, further comprising means for adjusting a stroke of the nose piece.

17. The portable device for inserting fixing elements according to claim 1, further comprising means for accommodating different fixing element barrel lengths.

18. A portable device for inserting fixing elements into predefined seats in a work piece, the portable device comprising:
a casing including a hand grip and a head;
a drive rod extending downward from the head;
a hollow, cylindrical-shaped nose piece slidably fit around a lower end of the drive rod, the nose piece being attached to the head and being movable vertically, with respect to the head and with respect to the drive rod, between a down position and an up position;
a magazine for sequentially feeding a first fixing elements into a horizontal slot on a lower face the nose piece, the slot of the nose piece being arranged such that the fixing element is disposed under a lower face of the drive rod;
and when the first fixing element at the lower end of the drive rod presses against the work piece and when downward pressure is simultaneously applied by a user on the casing, a mechanism in the head provides a pulsating force produced by a pressurized fluid to an upper end of the drive rod, the pulsating force on the drive rod driving the first fixing element into the predefined seat in the work piece.

19. A method for determining multiple predefined seat locations in a work piece and inserting fixing elements into the seats,
automatically transferring a first fixing element into a nose piece of a multi-blow pneumatic hand tool, a barrel tip of the fixing element extending below a lower face of the nose piece,
moving the nose piece over the work piece until the barrel tip of the first fixing element meets a first predefined seat;
inserting the first fixing element into the first seat by applying pressure on the nose piece;
automatically transferring a second fixing element from the magazine into the nose piece, a barrel tip of the second fixing element extending below the lower face of the nose piece;
moving the nose piece over the work piece until the barrel tip of the second fixing element meets a second predefined seat;
inserting the second fixing element into the second seat by applying the pressure on the nose piece; and
repeating the steps above until the multiple predefined seat locations are found and filled with the fixing elements.

20. The method according to claim 19, further comprising the step of:
automatically transferring the fixing elements one at a time from a magazine mounted on the nose piece at a predetermined angle with respect to a lower face of the nose piece;
feeding the fixing elements into a horizontal slot on the lower face the nose piece,
the slot of the nose piece being arranged such that the fixing elements are disposed under a lower face of the drive rod and such that the barrel tips of the fixing elements in the slot project below the lower face of the nose piece.
